(19) United States
(12) Patent Application Publication
(10) Pub. No.: US 2007/0016907 A1
(43) Pub. Date: Jan. 18, 2007

(54) METHOD, SYSTEM AND COMPUTER PROGRAM FOR AUTOMATIC PROVISIONING OF RESOURCES TO SCHEDULED JOBS

(76) Inventors: FABIO BENEDETTI, Roma (IT); JONATHAN WAGNER, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/457,042

(22) Filed: Jul. 12, 2006

(30) Foreign Application Priority Data
Jul. 12, 2005 (EP) 05106366.7

(51) Int. Cl. G06F 9/46

(52) U.S. Cl. 718/104

(57) ABSTRACT

A solution for allowing a scheduler (205) to interact with a provisioner (250) is proposed. Particularly, the scheduler submits different jobs for execution according to a predefined plan (225); for this purpose, each job requires a workstation with specific characteristics. In the proposed solution, the available workstations are partitioned into pools (each one associated with a corresponding category of jobs). Whenever a submitted job cannot be executed because no workstation (with the required characteristics) is available in the respective pool, the scheduler sends a corresponding request to the provisioner. In response thereto, the provisioner allocates further workstations to the pool (for example, according to user defined policies, a probability of breaching the time constraints of the jobs, or their priorities). In this way, additional resources can be allocated on-demand according to the contingent needs of the jobs that must be executed.

### FIELD OF THE INVENTION

The present invention relates to the data processing field. More specifically, the present invention relates to the scheduling of execution of work units in a data processing system.

### BACKGROUND ART

Scheduling of different work units (for example, batch jobs) is a commonplace activity in complex data processing systems. For this purpose, workload schedulers have been proposed in the last years to automate the submission of large quantities of jobs from a central point of control (according to a predefined plan). An example of scheduler is the “IBM Tivoli Workload Scheduler (TWS)” by IBM Corporation.

Each job requires several hardware and/or software resources for its execution (such as workstations). Typically, the required resources are specified through their properties; for example, it is possible to indicate that a generic job must be executed on a workstation having desired characteristics (such as operating system, number of processors, installed memory, and so on). In this way, the actual workstation to be used by the job can be selected dynamically at run-time.

The schedulers known in the art are very sophisticated in managing the submission of the jobs on the available workstations. For example, the schedulers can limit the number of jobs that are running concurrently on each workstation so as to avoid excessive contention for its use. Moreover, most schedulers are capable of optimizing the distribution of the jobs on the different workstations; for this purpose, the schedulers monitor the performance of the workstations and then assign the jobs to them according to load balancing policies; in this way, it is possible to uniform the workloads of the workstations in an attempt to increase the overall performance of the system.

However, the schedulers are completely ineffective in managing the problems caused by any lack of the required resources. Indeed, whenever no workstation with the characteristics needed by a job is available the job cannot be executed; in this case, the job is put in a waiting state until the required workstation is released by other jobs. Therefore, it is not possible to prevent bottlenecks or delays due to insufficient resources (for satisfying the requirements of the jobs). This drawback has a detrimental impact on the performance of the whole system. Particularly, it may happen that some jobs of the plan are not executed within their time constraints. The problem is particular acute for jobs relating to critical business activities, which must be completed in a very strict timeframe.

### SUMMARY OF THE INVENTION

The proposed solution is based on the idea of adding provisioning capabilities to the schedulers.

Particularly, an aspect of the invention proposes a method for scheduling execution of work units (such as batch jobs) in a data processing system. The system includes a plurality of resources (such as workstations), which are logically organized into a plurality of pools. The method starts with the step of providing a plan of execution of the work units; each work unit requires a resource (or more) of a corresponding pool for execution. Each work unit is then submitted for execution according to the plan. For each submitted work unit, the availability of each required resource in the corresponding pool is verified. The method continues requesting the provisioning of one or more further resources to the pool corresponding to at least one non-available required resource.

In a preferred embodiment of the invention, this result is achieved by exploiting a waiting queue (for example, processed periodically).

Advantageously, for each pool associated with the jobs in the waiting queue a corresponding provisioning request is submitted when a probability of breaching a performance goal of those jobs reaches a threshold value.

As a further enhancement, different priorities may be assigned to the jobs.

Preferably, the decision about the allocation of the workstations is taken according to the probability, the priorities, or both of them.

A suggested choice for estimating the probability is of calculating it according to the number of the corresponding jobs, to their waiting times, to the corresponding time constraints, or to any combination thereof.

A further aspect of the present invention proposes a computer program for performing the above-described method.

Moreover, another aspect of the present invention proposes a corresponding system.

The characterizing features of the present invention are set forth in the appended claims. The invention itself, however, as well as further features and the advantages thereof will be best understood by reference to the following detailed description, given purely by way of a nonrestrictive indication, to be read in conjunction with the accompanying drawings.

### REFERENCE TO THE DRAWINGS

FIG. 1a is a schematic block diagram of a data processing system in which the solution according to an embodiment of the invention is applicable;

FIG. 1b shows the functional blocks of an exemplary computer of the system;

FIG. 2 depicts the main software components that can be used for implementing the solution according to an embodiment of the invention; and

FIGS. 3a-3c show a diagram describing the flow of activities relating to an implementation of the solution according to an embodiment of the invention.

### DETAILED DESCRIPTION

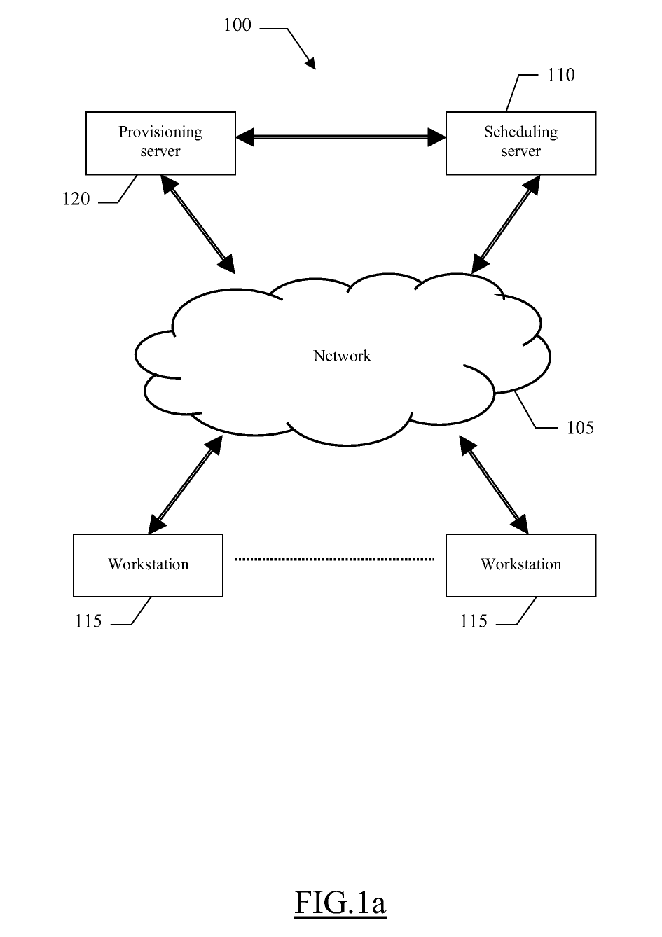

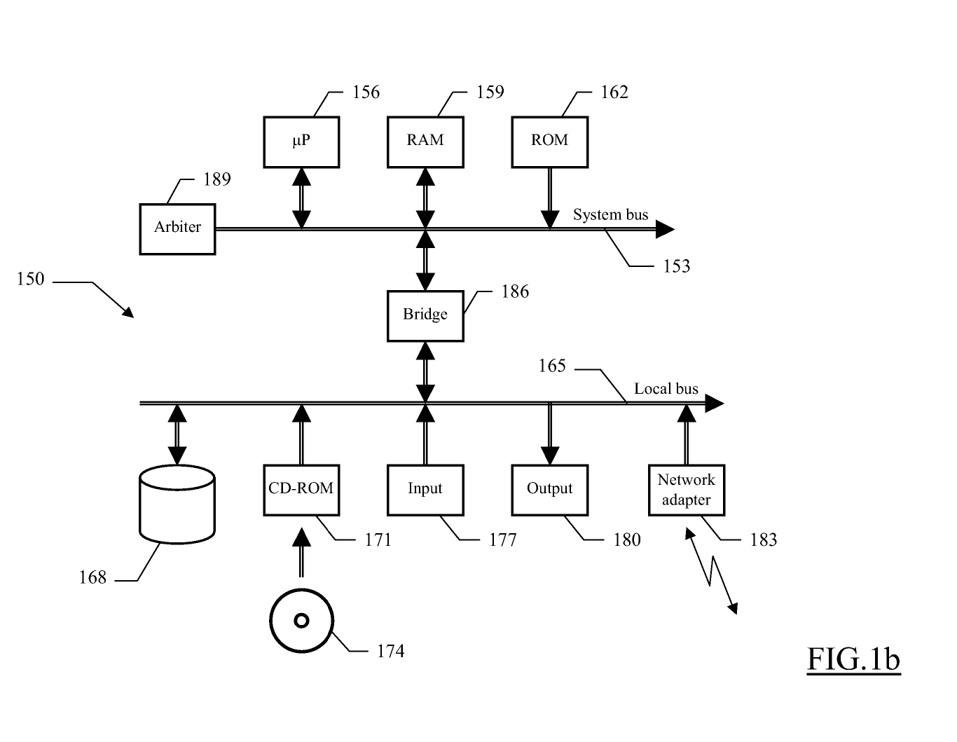

With reference in particular to FIG. 1a, a schematic block diagram of a data processing system 100 is illustrated. The system 100 has a distributed architecture based on a network 105 (typically consisting of the Internet).

Particularly, a central scheduling server 110 is used to automate, monitor and control the execution of work units in the system 100. Typically, the work units consist of non-interactive jobs (for example, payroll programs, cost analysis applications, and the like), which are to be executed on a set of workstations 115. For this purpose, the scheduling server 110 and the workstations 115 communicate through the network 105.

A provisioning server 120 is further connected to the network 105. The provisioning server 120 automatically adds or removes workstations 115 to/from the system 100 according to the corresponding real-time performance. In an embodiment of the invention, the provisioning server 120 also interfaces with the scheduling server 110 (so as to allow the scheduling server 110 to invoke its services directly).

Moving now to FIG. 1b, a generic computer of the above-described system (scheduling server, workstation or provisioning server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass memory consists of one or more hard-disks 168 and a drive 171 for reading CD-ROMs 174. Moreover, the computer 150 includes input units 177 (for example, a keyboard and a mouse), and output units 180 (for example, a monitor and a printer). An adapter 183 is used to connect the computer 150 to the network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

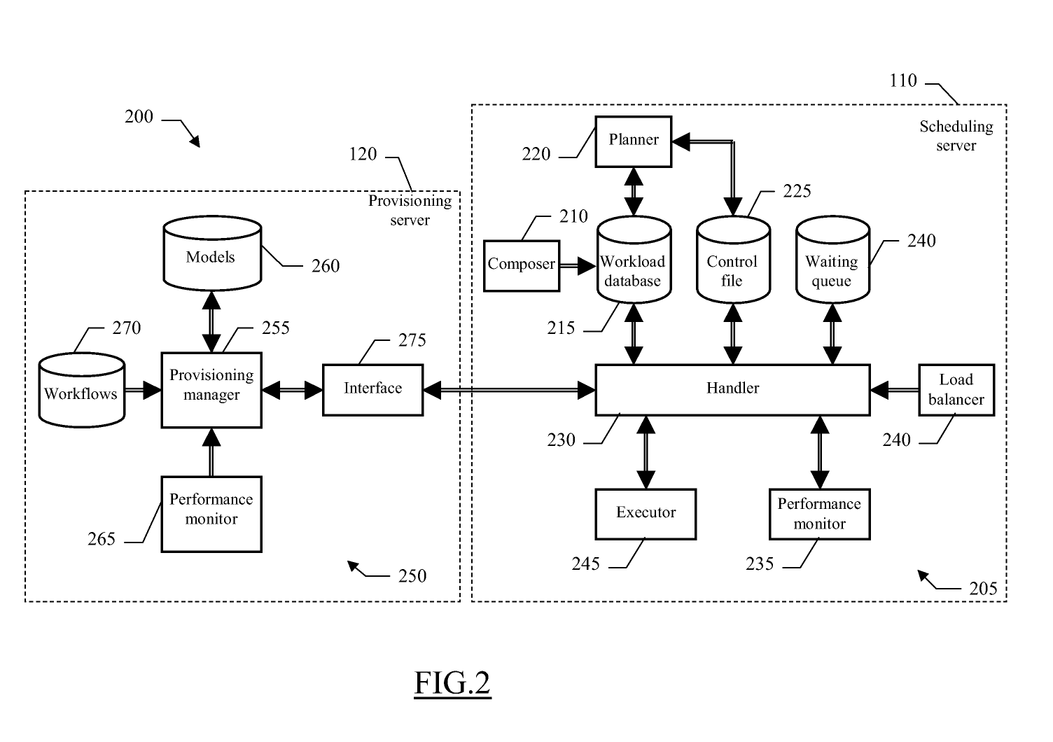

Moving now to FIG. 2, the main software components that run on the above-described system are denoted as a whole with the reference 200. The information (programs and data) is typically stored on the hard-disk and loaded (at least partially) into the working memory of each computer when the programs are running, together with an operating system and other application programs (not shown in the figure). The programs are initially installed onto the hard disk, for example, from CD-ROM.

Particularly, the server 110 runs a scheduler 205 (for example, the above-mentioned TWS). The scheduler 205 includes a composer 210, which is used to manage a workload database 215.

The workload database 215 contains the definition of the whole environment that is controlled by the scheduler 205. Particularly, the workload database 215 stores a representation of the topology of the system (i.e., the workstations with their connections) and of the hardware/software resources that are available (i.e., the physical/logical characteristics of the workstations, such as their processing power, hard-disk space, working memory size, operating system, software applications, databases, and the like). The workstations are logically partitioned into multiple pools, each one dedicated to a corresponding category of jobs.

The workload database 215 also includes a descriptor of each job (written in a suitable control language, for example, XML-based). The job descriptor specifies its category (which associates the job to the corresponding pool). Moreover, the job descriptor indicates the resources that are required for the execution; the required resources are specified with a formal definition (consisting of the characteristics of the workstation on which the job can be launched). The job descriptor then specifies the programs to be invoked (with their arguments and environmental variables). Typically, the execution of the job is subjected to a time constraint (such as a specific day, an earliest time or a latest time for its submission, or a maximum allowable duration). In this respect, it is also possible to specify a priority index for the compliance to the time constraint (for example, from 0 to 10 in increasing priority order); generally, the priority index is set to high values for jobs relating to critical business activities, which must be completed in a very strict timeframe. The job descriptor also allows specifying any dependencies of the job (i.e., conditions that must be met before the job can start); exemplary dependencies are sequence constraints (such as the successful completion of other jobs), or enabling constraints (such as the entering of a response to a prompt by an operator). Generally, the jobs are organized into streams; each job stream consists of an ordered sequence of jobs to be run as a single work unit respecting predefined dependencies (for example, jobs to be executed on the same day or using common resources). For the sake of simplicity, the term job will be used from now on to denote either a single job or a job stream (unless otherwise specified). The workload database 215 also stores statistics information relating to the execution of the jobs (such as a log of their duration from which a corresponding estimated duration may be inferred).

A planner 220 creates a workload plan, which consists of a batch of jobs (together with their dependencies) scheduled for execution on a specific production period (typically, one day); the plan is stored into a corresponding control file 225. A new plan is generally created automatically before every production day. For this purpose, the planner 220 processes the information available in the workload database 215 so as to select the jobs to be run and to arrange them in the desired sequence (according to their specifications). Typically, the jobs of the previous production day that did not complete successfully or that are still running or waiting to be run can be maintained in the plan (for execution during the next production day).

A handler 230 starts the plan at the beginning of every production day. The handler 230 submits each job for execution as soon as possible. For this purpose, the handler 230 at first verifies whether one or more workstations with the characteristics required by the job are available in the corresponding pool; the operation is based on information provided by a performance monitor 235, which continually measures the use of all the workstations managed by the scheduler 205 (as defined in the workload database 215). If the job cannot be executed at the moment (because no required workstation is available) it is inserted into a waiting queue 240.

Conversely, the job is executed on one of the available workstations of the corresponding pool. For this purpose, the handler 230 interfaces with a load balancer 240; the load balancer 240 is used to distribute the execution of the jobs throughout the workstations in an attempt to optimize overall performance of the system. The actual execution of the job is managed by a corresponding module 245. The executor 245 directly launches and tracks the job (by interfacing with a corresponding agent running on the assigned workstation). The executor 245 returns feedback information about the execution of the job to the handler 230 (for example, whether the job has been completed successfully, its actual duration, and the like); the handler 230 enters this information into the control file 225. In such a way, the control file 225 is continuously updated so as to provide a real-time picture of the current state of all the jobs of the plan. At the end of the production day, the planner 220 accesses the control file 225 for updating the statistics information relating to the executed jobs in the workload database 215.

On the other hand, the server 120 runs a provisioner 250 (for example, the “IBM Tivoli Provisioning Manager or TPM” by IBM Corporation). The core of the provisioner 250 consists of a manager 255, which controls the allocation of the workstations in the system. For this purpose, the provisioning manager 255 stores a virtual representation of the system into a model repository 260. The model repository 260 defines multiple types of applications (such as web services, database facilities, batch jobs, and the like); each application type shares a corresponding pool of workstations. Particularly, each job category defined in the workload database 215 is associated with a corresponding application type in the model repository 260 (with the same pool of workstations). Moreover, for each application type the model repository 260 also specifies an allocation policy; the allocation policy defines the conditions that control the allocation of the workstations to the corresponding pool (for example, so as to ensure a desired service level).

The provisioning manager 255 interfaces with a performance monitor 265; the performance monitor 265 continually measures state parameters (or metrics) of the managed workstations (such as their processing power usage, hard-disk occupation, working memory consumption, and the like). Whenever the measured state parameters indicate a critical condition that should impair the desired service level of a generic application type, the provisioning manager 255 will take appropriate actions in an attempt to prevent the problem (as defined by the corresponding allocation policy in the model repository 260). For example, the provisioning manager 255 may add further workstations to the pool or move some workstations from another (under-exploited) pool. At the same time, the provisioning manager 255 automatically configures the (added or moved) workstations for the required tasks; the operations to be executed for this purpose (such as install software applications, configure system parameters, set up hardware devices, and the like) are defined by corresponding workflows, which are stored into a database 270.

In an embodiment of the invention, the provisioner 250 has been customized by the addition of a plug-in interface 275. As described in detail in the following, the interface 275 allows the handler 230 (of the scheduler 205) to invoke the provisioning manager 255 directly; in this way, the scheduler 205 is allowed to request the allocation of further workstations to the pools associated with the different job categories according to its contingent needs.

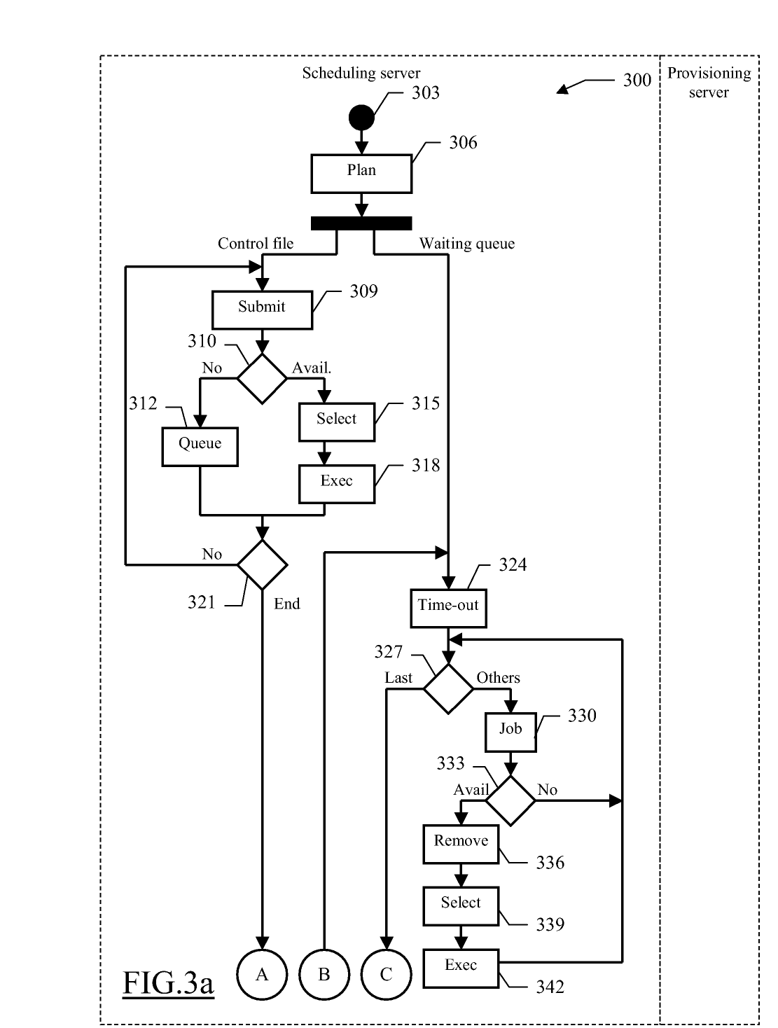

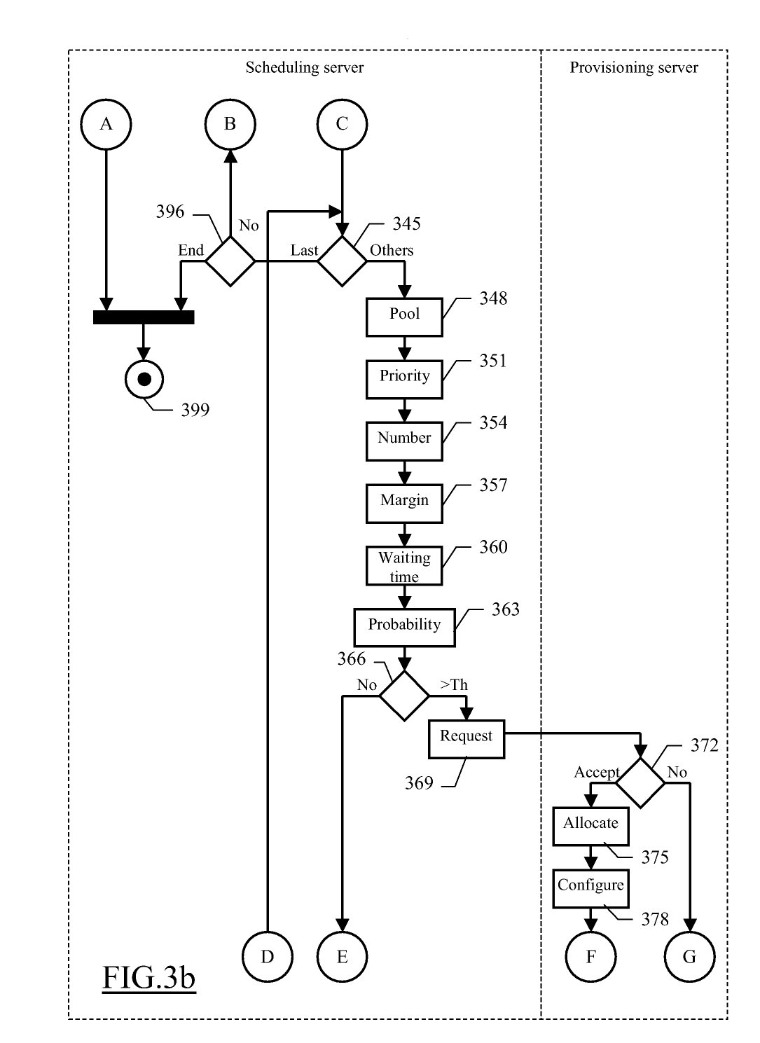

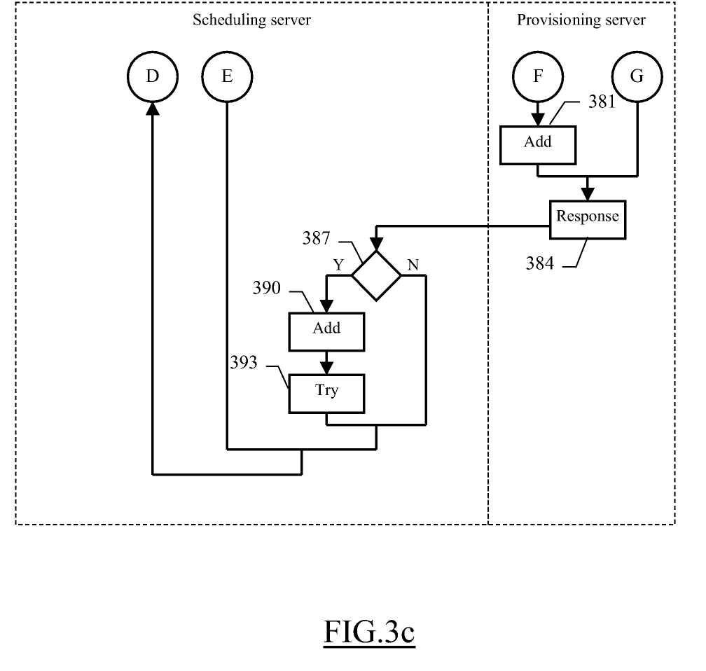

Moving now to FIGS. 3a-3c, the logic flow of an exemplary process that can be implemented in the above-described system (for scheduling the execution of the jobs) is represented with a method 300. The method 300 begins at the black start circle 303 in the swim-lane of the scheduling server, and then passes to block 306 wherein a new plan is submitted for execution (at the beginning of the production day).

The method then forks into two branches that are executed concurrently. A first branch (for processing the control file) consists of blocks 309-321, and a second branch (for processing the waiting queue) consists of blocks 324-396; the two branches joint at the concentric white/black stop circles 399.

Considering now block 309 (control file) a generic job of the plan is submitted for execution as soon as possible (according to its time constraint and dependencies). A test is then made at block 310 to determine whether the resources required for the execution of the (submitted) job are available; for this purpose, the handler verifies whether one or more workstations with the desired characteristics in the corresponding pool can be used. If not, the method continues to block 312; in this phase, the job is added to the waiting queue, together with a corresponding timestamp (updating the control file accordingly).

Conversely, the handler invokes the load balancer at block 315. The load balancer selects the workstation (among the available ones) to be assigned to the job; for example, this process is performed according to a predefined algorithm, which is based on the measured workloads of the available workstations and an estimated weight of the job. The job is then launched on the selected workstation at block 318 (updating the control file accordingly). Once the job completes, feedback information is returned to the handler, which enters this information into the control file.

In any case, the flow of activity proceeds to block 321 (either from block 312 or from block 318). If the plan has not been completed yet, the method returns to block 309 for repeating the same operations described above; on the contrary, the branch ends at the stop circles 399.

With reference instead to block 324 (waiting queue), the handler is in a suspended condition. As soon as a predefined time-out (for example, of a few minutes) expires, a loop is performed for processing all the jobs in the waiting queue (according to a FIFO policy). The loop begins at block 327, wherein a test is made to determine whether the end of the waiting queue has been reached. If not, the handler at block 330 retrieves the relevant information of a current one of the jobs in the waiting queue (from the workload database). If the resources required for the execution of the job are now available (block 333) the method continues to block 336; for example, this condition occurs when workstations with the required characteristics have been released by other jobs of the same category that completed their execution or because further workstations have been allocated to the corresponding pool (as described in the following). In this case, the job is removed from the waiting queue. Moving to block 339, the workstation to be assigned to the job is selected by the load balancer. The job can now be launched on the selected workstation at block 342 (updating the control file accordingly). The flow of activity then returns to block 327 for verifying again the exit condition of the loop; the same point is also reached from block 333 directly when the resources required for the execution of the job are still not available.

Once all the jobs in the waiting queue have been processed (or the waiting queue is empty), the method from block 327 enters a further loop for processing all the pools associated with the jobs in the waiting queue. The loop begins at block 345, wherein a test is made to determine whether the operation has been completed. If not, the handler at block 348 selects the jobs in the waiting queue associated with a current one of the pools (starting from the first one as defined, for example, in the workload database). Proceeding to block 351, the handler identifies the highest priority index of the selected jobs. The method then passes to block 354, wherein the number of the selected jobs (Np) is determined. With reference now to block 357, for each selected job a safety margin is calculated as the difference between its objective starting time and the current time; the shorter safety margin (Sp), representing the risk of breaching the time constraints of the selected jobs, is then identified. Descending into block 360, the handler determines the waiting time of each selected job (as the difference between the current time and the corresponding timestamp being set at the insertion of the selected job in the waiting queue); the average of those waiting times (Wp) is then calculated. A probability index (Ip) can now be associated with the pool at block 363. The probability index provides an estimation of the likelihood that the selected jobs are not executed within their time constraints. This probability index increases with the number of the selected jobs and with their (average) waiting time, whereas it decreases with the corresponding (shorter) safety margin. For example, it is possible to normalize the number of the selected jobs Np, the safety margin Sp and the waiting time Wp according to a maximum capacity of the waiting queue MaxN, a maximum safety margin MaxS (such as equal to the length of the production day), and a maximum waiting time MaxW (such as equal to the same length of the production day). The (normalized) safety margin Sp/MaxS is complemented to 1, so as to obtain a value that increases with the risk of breaching the time constraints of the selected jobs. The probability index is now calculated by summing the above-mentioned parameters weighted by predefined factors indicative of their relevance (i.e., Fn for the number, Fw for the waiting time, and Fs for the complemented safety margin):

$$lp = \frac{Fn \cdot N p / Max N + Fw \cdot Wp / Max W + Fs \cdot ( 1 - Sp / Max S )}{Fn + Fw + Fs} .$$

The flow of activity then branches at block 366. Particularly, if the probability index exceeds a predefined threshold value (such as 0.5-0.7) or the (highest) priority index exceeds a further threshold value (such as 5-7), a corresponding request is submitted to the provisioning server at block 369. The provisioning request includes an identifier of the pool (for which further workstations are necessary), together with the corresponding probability index and priority index; moreover, the provisioning request also includes an address of the scheduling server (to which a corresponding response has to be returned). In this way, the provisioning request is submitted as soon as there is a substantial risk of breaching the time constraints of the selected jobs. At the same time, the provisioning request is always submitted when one or more of the selected jobs have a high priority (irrespectively of the probability index). It should be noted that those results are achieved by processing the waiting queue periodically; this provides a good compromise between the opposed requirements of low response time and implementation simplicity.

In response thereto, the provisioning server at block 372 decides whether the request can be satisfied. First of all, the decision is based on the availability of the required workstations (or on the possibility of removing them from other pools). The decision is then based on the corresponding allocation policy, taking into account the probability index and the priority index. In the affirmative case, the provisioning server at block 375 allocates a new workstation (or more) to the pool. Continuing to block 378, the new workstation is configured according to the corresponding workflow. This workstation is then added to the pool associated with the job category in the model repository (block 381). The flow of activity now descends into block 384; the same point is also reached from block 372 directly when the provisioning request cannot be satisfied. In any case, a corresponding response is returned to the scheduler (specifying the freshly added workstation or a refusal code).

The handler operates accordingly at block 387. Particularly, if the provisioning request has been satisfied the new workstation is likewise added to the workflow database for the corresponding pool at block 390. Continuing to block 393, the handler try to launch the selected jobs immediately by exploiting the workstations that are now available; preferably, the selected jobs are processed in decreasing priority order (according to a FIFO policy for the same priority index); at the same time, each selected job that is successfully launched is removed from the waiting queue.

The flow of activity then returns to block 345 for verifying again the exit condition of the loop; the same point is also reached from block 387 directly when the provisioning request has been refused (so that no action is taken for the selected jobs). Once all the pools associated with the jobs in the waiting queue have been processed (or the waiting queue is empty), the decision block 396 is entered from block 345. If the plan has not been completed yet, the method returns to block 324 for repeating the same operations described above periodically; on the contrary, the branch ends at the stop circles 399.

The proposed solution integrates the provisioner with the scheduler, so as to allow adding additional resources to the jobs on-demand (dynamically). In this way, the scheduler is now capable of managing the problems caused by any lack of the required resources. Particularly, whenever no workstation with the characteristics needed by a job is available the scheduler may request the provisioner to allocate further workstations to the corresponding pool. As a result, it is possible to reduce (or even avoid at all) the waiting time of the jobs. This approach prevents bottlenecks or delays due to insufficient resources (for satisfying the requirements of the jobs). All of the above has a beneficial impact on the performance of the whole system. Particularly, this strongly reduces the risk of having some jobs of the plan that cannot be executed within their time constraints (especially when they relate to critical business activities).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the system has a different architecture or includes equivalent units (for example, with the scheduling server and the provisioning server that are collapsed into a single computer). Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

The invention has equal applicability to equivalent schedulers (for example, having another architecture, working on a single computer, or used to control the execution of other work units such as interactive tasks). Likewise, the jobs may require any physical or logical resources (such as networks, communication ports, transmission channels, user privileges, and the like); moreover, it is possible to partition the resources into the pools according to whatever criterion (for example, based on their geographical locations).

The solution according to the present invention leads itself to be implemented using an equivalent memory structure for managing the jobs in the waiting condition; in addition or in alternative to its periodic processing, it is also possible to verify the availability of the required resources when every job completes (and releases the corresponding workstation). In any case, nothing prevents submitting the provisioning request immediately when each job cannot be executed (without the delay for the processing of the waiting queue).

Alternatively, the probability index may be replaced with an equivalent indicator of the risk of breaching a generic performance goal of each job and/or the priority index may be replaced with an equivalent indicator of its relevance. In any case, a simplified implementation that does not support the probability index, the priority index, or even both of them is not excluded.

Alternatively, the probability index and/or the priority index are used to decide the submission of the provisioning requests only (but they do not affect the process of deciding the allocation of the required workstations).

It should be readily apparent that the probability index may be calculated in a number of other ways; for example, the different parameters may be combined into the probability index with a different formula, or different or additional parameters may be taken into account (such as the maximum waiting time of the corresponding jobs).

Similar considerations apply if the program (which may be used to implement the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (for example, with similar or additional steps). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for scheduling execution of work units in a data processing system including a plurality of resources logically organized into a plurality of pools, wherein the method includes the steps of:
providing a plan of execution of the work units, each work unit requiring at least one resource of a corresponding pool for execution,
submitting each work unit for execution according to the plan,
for each submitted work unit, verifying an availability of each required resource in the corresponding pool, and
requesting the provisioning of at least one further resource to the pool corresponding to at least one non-available required resource.

2. The method according to claim 1, further including the steps of:
inserting each submitted work unit into a waiting queue in response to the non-availability,
for each submitted work unit in the waiting queue, verifying a further availability of each required resource in the corresponding pool,
extracting each submitted work unit from the waiting queue in response to the further availability, and
executing each submitted work unit extracted from the waiting queue.

3. The method according to claim 2, wherein the step of requesting the provisioning includes, for each selected pool of the non-available resources required by a corresponding set of selected submitted work units in the waiting queue:
estimating a probability of breaching a performance goal of the selected submitted work units, and
submitting a provisioning request for the provisioning of at least one further resource to the selected pool when the probability reaches a threshold value.

4. The method according to claim 3, wherein a priority is associated with each selected submitted work unit, the method further including the step of:
submitting the provisioning request for the provisioning of at least one further resource to the selected pool according to a comparison between the priorities of the selected submitted work units and a further threshold value.

5. The method according to claim 3, further including the step in response to the provisioning request of:
deciding the provisioning of the at least one further resource to the selected pool according to the probability and/or the priorities.

6. The method according to claim, wherein the step of estimating the probability includes:
measuring a number of the selected submitted work units, and
determining the probability according to the measured number.

7. The method according to claim 3, wherein the step of estimating the probability includes:
measuring a waiting time of each selected submitted work unit in the waiting queue, and
determining the probability according to the measured waiting times.

8. The method according to claim 3, wherein a time constraint is associated with each selected submitted work unit, the step of estimating the probability including:
determining the probability according to a comparison between a current time and the time constraints of the selected submitted work units.

9. A computer program in a computer readable medium for scheduling execution of work units in a data processing system including a plurality of resources logically organized into a plurality of pools, wherein the method comprising:
instructions for providing a plan of execution of the work units, each work unit requiring at least one resource of a corresponding pool for execution,
instructions for submitting each work unit for execution according to the plan,
instructions for each submitted work unit, verifying an availability of each required resource in the corresponding pool, and
instructions for requesting the provisioning of at least one further resource to the pool corresponding to at least one non-available required resource.

10. A system for scheduling execution of work units in a data processing system including a plurality of resources logically organized into a plurality of pools, wherein the method comprising:
means for providing a plan of execution of the work units, each work unit requiring at least one resource of a corresponding pool for execution,
means for submitting each work unit for execution according to the plan,
means for each submitted work unit, verifying an availability of each required resource in the corresponding pool, and
means for requesting the provisioning of at least one further resource to the pool corresponding to at least one non-available required resource.
